(19) United States
(12) Patent Application Publication
(10) Pub. No.: US 2011/0235981 A1
(43) Pub. Date: Sep. 29, 2011

(54) CONNECTOR APPARATUS FOR DOWNHOLE TOOL

(75) Inventors: Oguzhan Guven, Houston, TX (US); Philippe Gambier, Luanda Port (AO)

(73) Assignee: SCHLUMBERGER TECHNOLOGY CORPORATION, Sugar Land, TX (US)

(21) Appl. No.: 12/748,590

(22) Filed: Mar. 29, 2010

(51) Int. Cl. G02B 6/255; H02G 15/10; B23K 31/02

(52) U.S. Cl. 385/95; 174/84 R; 174/84 C; 228/101; 228/155

(57) ABSTRACT

Embodiments and methods are disclosed herein that relate to a connection assembly to communicatively couple one or more cables to each other. The connection assembly includes a cable having a housing with a communication line disposed therein, a connection apparatus having a housing with a communication line disposed therein, and a weld coupling disposed between an end of the housing of the connection apparatus and an end of the housing of the cable such that the end of the housing of the connection apparatus and the end of the housing of the cable are connected to each other through the weld coupling. The communication line of the connection apparatus is communicatively coupled to the communication line of the cable, and the end of the housing of the connection apparatus has substantially the same diameter as the end of the housing of the cable.

### BACKGROUND OF DISCLOSURE

1. Field of the Disclosure

Embodiments disclosed herein generally relate to an apparatus used to connect one or more cables to each other. More specifically, embodiments disclosed herein relate to an improved apparatus and assembly to connect at least two cables to each other disposed within a well, such as on an oil or gas well.

2. Background Art

Communication lines are used in a wide range of applications in the oilfield industry. These communication lines may be used to transmit power and/or data between the surface of a well and one or more tools disposed downhole within the well. For example, communication lines may be used to transmit data from downhole tools, such as data related to pressure and/or temperature monitored downhole, to instrumentation disposed at the surface of the well. The communication lines may also be used to send information from the surface to one or more of the tools disposed downhole within the well. Further, communication lines may be used to electrically power downhole equipment, particularly tools disposed downhole. These communication lines may include electrical lines, optical fiber lines, and/or other lines and methods for data or power transmission.

In certain environments, such as those often encountered downhole within the oilfield industry, the communication lines may be exposed to hostile conditions, such as elevated temperatures and pressures, not common with most communication applications. To protect the communication lines from the hostile conditions, the communication lines are generally carried within a protective tubing to provide an environmental seal about the lines. As such, the protective tubing and/or the environmental seal covering the communication lines may have to be modified and/or reformed at times, such as during assembly, installation, and/or repair of the communication lines. For example, in a downhole application, when a communication line needs to be fed through a downhole tool, such as a packer disposed downhole, the communication line may need to be cut and spliced to establish communication with the downhole tool and also with the remainder of the communication line disposed downhole. After the splicing of the communication line, the communication line must then again be sealed to protect the communication line from the hostile conditions.

When reforming the connection between the sections of communication lines, the reformed connections of the protective tubing and seal may be larger than the initial protective tubings and seals contained around the connection lines. For example, when reforming connections between communication lines, which often occur at the site of the well, the communication lines must be quickly and reliably reconnected to each other so as to save as much time as possible while also adequately protecting the communication lines from the downhole environment. As such, because of the relative ease and convenience, it is common to use connections and methods that provide larger diameters for the reformed communication lines than initially present. However, the larger reformed communication lines may not provide the minimized sizing needed for the downhole operations and tools being used at the well. Thus, there exists a need for apparatuses and methods to splice communication lines that may be able to overcome these size limitations while still protecting the communication lines from the surrounding environment.

### SUMMARY OF INVENTION

In one aspect, embodiments disclosed herein relate to a connection assembly to be used with a downhole tool. The assembly includes a first cable having a housing with a communication line disposed therein, a second cable having a housing with a communication line disposed therein, and a connection apparatus. The connection apparatus includes a housing having a first end and a second end with a communication line disposed within the housing. The communication line of the connection apparatus is communicatively coupled between the communication line of the first cable and the communication line of the second cable. The first end of the housing of the connection apparatus is connected to the housing of the first cable using a first weld coupling. The second end of the housing of the connection apparatus is connected to the housing of the second cable using a second weld coupling. Further, the housing of the connection apparatus has substantially the same diameter as the housing of the first cable and the housing of the second cable.

In another aspect, embodiments disclosed herein relate to a connection assembly to communicatively couple one or more cables together. The connection assembly includes a cable having a housing with a communication line disposed therein, a connection apparatus having a housing with a communication line disposed therein, and a weld coupling disposed between an end of the housing of the connection apparatus and an end of the housing of the cable. The weld coupling may be disposed such that the end of the housing of the connection apparatus and the end of the housing of the cable are connected to each other through the weld coupling. The communication line of the connection apparatus is communicatively coupled to the communication line of the cable. In addition, the end of the housing of the connection apparatus has substantially the same diameter as the end of the housing of the cable.

In another aspect, embodiments disclosed herein relate to a method to communicatively couple one or more cables to a downhole tool. The method includes communicatively coupling a communication line of a connection apparatus to a communication line of a first cable, and communicatively coupling the communication line of the connection apparatus to a communication line of a second cable. The method further includes welding a first end of a housing of the connection apparatus to an end of a housing of the first cable with a first weld coupling, and welding a second end of the housing of the connection apparatus to an end of a housing of the second cable with a second weld coupling. The communication line of the connection apparatus is disposed, at least partially, within the housing of the connection apparatus. In addition, the housing of the connection apparatus has substantially the same diameter as the housing of the first cable and the housing of the second cable.

In another aspect, embodiments disclosed herein relate to a method to communicatively couple one or more cables together. The method includes removing insulation between a housing and a communication line of a cable, and disposing a thermal insulator about at least one of the communication line of the cable and a communication line of a connection apparatus. In addition, the method further includes communicatively coupling the communication line of the connection apparatus to the communication line of the cable, and welding an end of a housing of the connection apparatus to an end of the housing of the first cable with a weld coupling. The thermal insulator is disposed between the weld coupling and the at least one of the communication line of the cable and the communication line of the connection apparatus. In addition, the end of the housing of the connection apparatus has substantially the same diameter as the end of the housing of the cable.

Other aspects and advantages of the invention will be apparent from the following description and the appended claims.

### BRIEF DESCRIPTION OF DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. The figures are as follows:

FIG. 1 shows a side view of a wellsite having a drilling rig with a drill string suspended therefrom in accordance with one or more embodiments of the present disclosure;

FIG. 2 shows a side view of a tool in accordance with one or more embodiments of the present disclosure;

FIG. 3 shows a side view of a tool in accordance with one or more embodiments of the present disclosure;

FIGS. 4A and 4B show cross-sectional views of a cable in accordance with one or more embodiments of the present disclosure; and

FIGS. 5A and 5B show cross-sectional views of a connection assembly in accordance with one or more embodiments of the present disclosure.

### DETAILED DESCRIPTION

It is to be understood that the following disclosure provides various embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

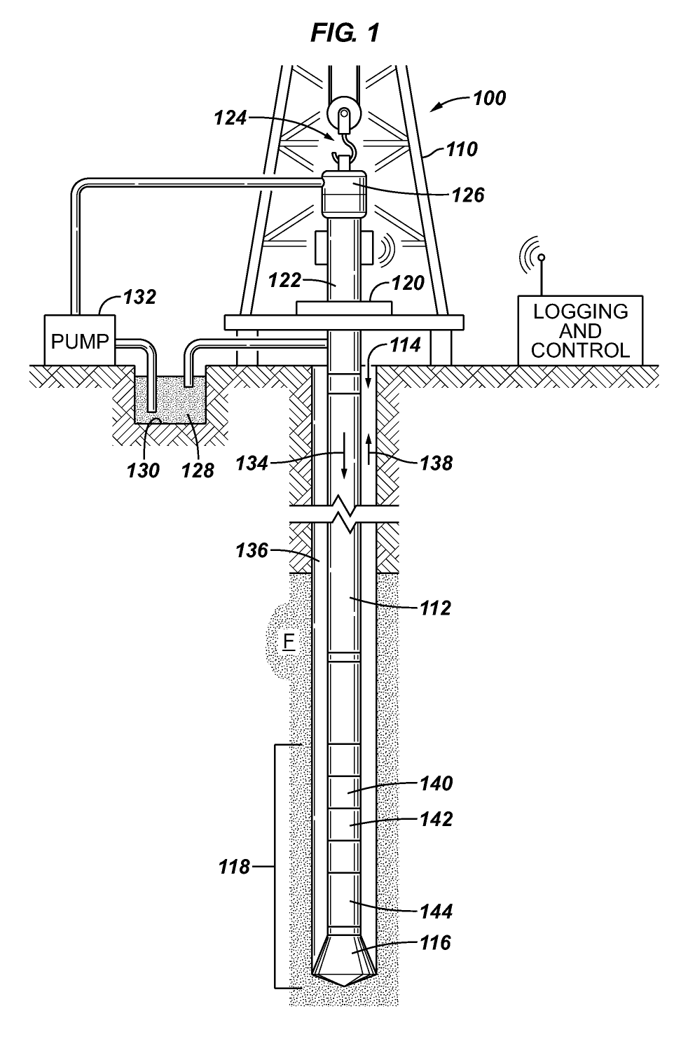

Referring now to FIG. 1, a side view of a wellsite 100 having a drilling rig 110 with a drill string 112 suspended therefrom in accordance with one or more embodiments of the present disclosure is shown. The wellsite 100 shown, or one similar thereto, may be used within onshore and/or offshore locations. In this embodiment, a borehole 114 may be formed within a subsurface formation F, such as by using rotary drilling, or any other method known in the art. As such, one or more embodiments in accordance with the present disclosure may be used within a wellsite, similar to the one as shown in FIG. 1 (discussed more below). Further, those having ordinary skill in the art will appreciate that the present disclosure may be used within other wellsites and/or downhole operations without departing from the scope of the present disclosure.

Continuing with FIG. 1, the drill string 112 may suspend from the drilling rig 110 into the borehole 114. The drill string 112 may include a bottom hole assembly 118 and a drill bit 116, in which the drill bit 116 may be disposed at an end of the drill string 112. The surface of the wellsite 100 may have the drilling rig 110 positioned over the borehole 114. In addition, the drilling rig 110 may include a rotary table 120, a kelly 122, a traveling block or hook 124, and may additionally include a rotary swivel 126. The rotary swivel 126 may be suspended from the drilling rig 110 through the hook 124, and the kelly 122 may be connected to the rotary swivel 126 such that the kelly 122 may rotate with respect to the rotary swivel.

Further, an upper end of the drill string 112 may be connected to the kelly 122, such as by threadingly connecting the drill string 112 to the kelly 122. The rotary table 120 may rotate the kelly 122, thereby rotating the drill string 112 connected thereto. As such, the drill string 112 may be able to rotate with respect to the hook 124. Those having ordinary skill in the art, however, will appreciate that though a rotary drilling system is shown in FIG. 1, other drilling systems may be used without departing from the scope of the present disclosure. For example, a top-drive (also known as a “power swivel”) system may be used in accordance with one or more embodiments without departing from the scope of the present disclosure. In such a top-drive system, the hook 124, swivel 126, and kelly 122 are replaced by a drive motor (electric or hydraulic) that may apply rotary torque and axial load directly to drill string 112.

The wellsite 100 may further include drilling fluid 128 (also known as drilling “mud”) stored in a pit 130. The pit 130 may be formed adjacent to the wellsite 100, as shown, in which a pump 132 may be used to pump the drilling fluid 128 into the wellbore 114. In this embodiment, the pump 132 may pump and deliver the drilling fluid 128 into and through a port of the rotary swivel 126, thereby enabling the drilling fluid 128 to flow into and downwardly through the drill string 112, the flow of the drilling fluid 128 indicated generally by direction arrow 134. This drilling fluid 128 may then exit the drill string 112 through one or more ports disposed within and/or fluidly connected to the drill string 112. For example, in this embodiment, the drilling fluid 128 may exit the drill string 112 through one or more ports formed within the drill bit 116.

As such, the drilling fluid 128 may flow back upwardly through the borehole 114, such as through an annulus 136 formed between the exterior of the drill string 112 and the interior of the borehole 114, the flow of the drilling fluid 128 indicated generally by direction arrow 138. With the drilling fluid 128 following the flow pattern of direction arrows 134 and 138, the drilling fluid 128 may be able to lubricate the drill string 112 and the drill bit 116, and/or may be able to carry formation cuttings formed by the drill bit 116 (or formed by any other drilling components disposed within the borehole 114) back to the surface of the wellsite 100. As such, this drilling fluid 128 may be filtered and cleaned and/or returned back to the pit 130 for recirculation within the borehole 114.

Though not shown in this embodiment, the drill string 112 may further include one or more stabilizing collars. A stabilizing collar may be disposed within and/or connected to the drill string 112, in which the stabilizing collar may be used to engage and apply a force against the wall of the borehole 114. This may enable the stabilizing collar to prevent the drill string 112 from deviating from the desired direction for the borehole 114. For example, during drilling, the drill string 112 may “wobble” within the borehole 114, thereby enabling the drill string 112 to deviate from the desired direction of the borehole 114. This wobble may also be detrimental to the drill string 112, components disposed therein, and the drill bit 116 connected thereto. However, a stabilizing collar may be used to minimize, if not overcome altogether, the wobble action of the drill string 112, thereby possibly increasing the efficiency of the drilling performed at the wellsite 100 and/or increasing the overall life of the components at the wellsite 100.

As discussed above, the drill string 112 may include a bottom hole assembly 118, such as by having the bottom hole assembly 118 disposed adjacent to the drill bit 116 within the drill string 112. The bottom hole assembly 118 may include one or more components included therein, such as components to measure, process, and store information. Further, the bottom hole assembly 118 may include components to communicate and relay information to the surface of the wellsite.

As such, in this embodiment shown in FIG. 1, the bottom hole assembly 118 may include one or more logging-while-drilling (“LWD”) tools 140 and/or one or more measuring-while-drilling (“MWD”) tools 142. Further, the bottom hole assembly 118 may also include a steering-while-drilling system (e.g., a rotary-steerable system) and motor 144, in which the rotary-steerable system and motor 144 may be coupled to the drill bit 116.

The LWD tool 140 shown in FIG. 1 may include a thick-walled housing, commonly referred to as a drill collar, and may include one or more of a number of logging tools known in the art. Thus, the LWD tool 140 may be capable of measuring, processing, and/or storing information therein, as well as capabilities for communicating with equipment disposed at the surface of the wellsite 100.

Further, the MWD tool 142 may also include a housing (e.g., drill collar), and may include one or more of a number of measuring tools known in the art, such as tools used to measure characteristics of the drill string 112 and/or the drill bit 116. The MWD tool 142 may also include an apparatus for generating and distributing power within the bottom hole assembly 118. For example, a mud turbine generator powered by flowing drilling fluid therethrough may be disposed within the MWD tool 142. Alternatively, other power generating sources and/or power storing sources (e.g., a battery) may be disposed within the MWD tool 142 to provide power within the bottom hole assembly 118. As such, the MWD tool 142 may include one or more of the following measuring tools: a weight-on-bit measuring device, a torque measuring device, a vibration measuring device, a shock measuring device, a stick slip measuring device, a direction measuring device, an inclination measuring device, and/or any other device known in the art used within an MWD tool.

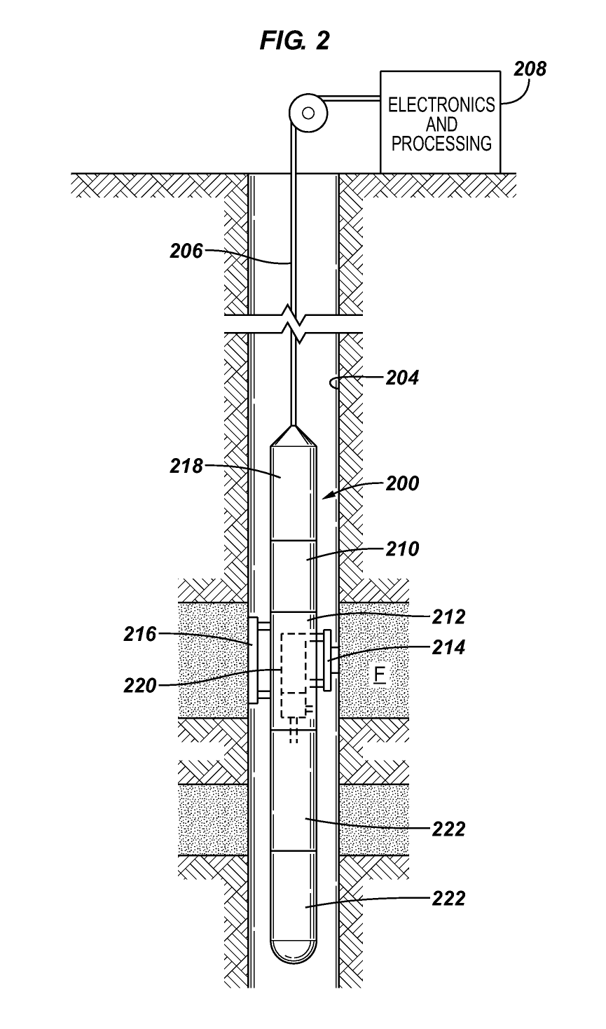

Referring now to FIG. 2, a side view of a tool 200 in accordance with one or more embodiments of the present disclosure is shown. In this embodiment, the tool 200 may be a “wireline” tool, in which the tool 200 may be suspended within a borehole 204 formed within a subsurface formation F. As such, the tool 200 may be suspended from an end of a cable 206 (e.g., a multi-conductor cable) located at the surface of the formation F, such as by having the cable 206 spooled around a winch (not shown) disposed on the surface of the formation F. The cable 206 is then coupled the tool 200 with an electronics and processing system 208 disposed on the surface.

The tool 200 shown in this embodiment may have an elongated body 210 that includes a formation tester 212 disposed therein. The formation tester 212 may include an extendable probe 214 and an extendable anchoring member 216, in which the probe 214 and anchoring member 216 may be disposed on opposite sides of the body 210. One or more other components 218, such as a measuring device, may also be included within the tool 200.

The probe 214 may be included within the tool 200 such that the probe 214 may be able to extend from the body 210 and then selectively seal off and/or isolate selected portions of the wall of the borehole 204. This may enable the probe 214 to establish pressure and/or fluid communication with the formation F to draw fluid samples from the formation F. The tool 200 may also include a fluid analysis tester 220 that is in fluid communication with the probe 214, thereby enabling the fluid analysis tester 220 to measure one or more properties of the fluid. The fluid from the probe 214 may also be sent to one or more sample chambers or bottles 222, which may receive and retain fluids obtained from the formation F for subsequent testing after being received at the surface. The fluid from the probe 214 may also be sent back out into the borehole 204 or formation F. As such, a pumping system may be included within the tool 200 to pump the formation fluid circulating within the tool 200. For example, the pumping system may be used to pump formation fluid from the probe 214 to the sample bottles 222 and/or back into the formation F.

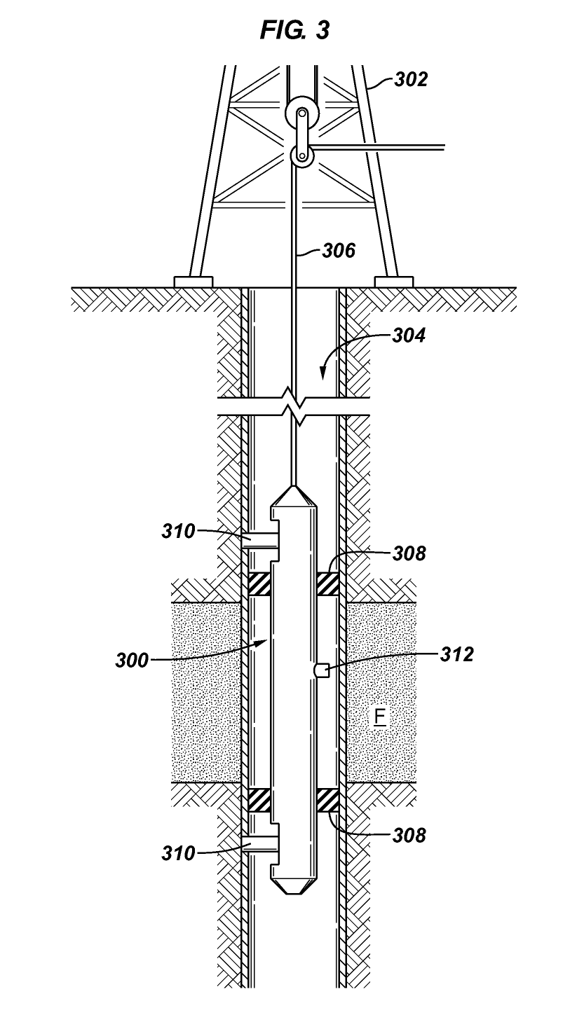

Referring now to FIG. 3, a side view of another tool 300 in accordance with one or more embodiments of the present disclosure is shown. Similar to the above embodiment in FIG. 2, the tool 300 may be suspended within a borehole 304 formed within a subsurface formation F using a cable 306. In this embodiment, the multi-conductor cable 306 may be supported by a drilling rig 302.

As shown in this embodiment, the tool 300 may include one or more packers 308 that may be configured to inflate, thereby selectively sealing off a portion of the borehole 304 for the tool 300. Further, to test the formation F, the tool 300 may include one or more probes 310, and the tool 300 may also include one or more outlets 312 that may be used to inject fluids within the sealed portion established by the packers 308 between the tool 300 and the formation F. As such, similar to the above embodiments, a pumping system may be included within the tool 300 to pump fluid circulating within the tool 300. For example, the pumping system may be used to selectively inflate and/or deflate the packers 308, in addition to pumping fluid out of the outlet 312 into the sealed portion formed by the packers 308.

As discussed above, a connection apparatus in accordance with the present disclosure may be included within one or more embodiments shown in FIGS. 1-3, in addition to being included within other downhole operations and/or with other tools and devices that may be disposed downhole within a formation, such as with permanent and retrievable completion components, among others. The connection apparatus, thus, may be used within a downhole operation, such as a drilling or testing operation, to provide transmit power and/or data through one or more communication lines in use with the well. For example, as shown above with respect to FIGS. 1-3, a connection apparatus may be used within a number of embodiments, such as for enabling communication with a downhole tool with the surface and/or enabling communication between one or more downhole tools. In particular, in one or more embodiments, a connection apparatus in accordance with the present disclosure may be used within splicing a cable that is to be used within a downhole environment.

Thus, in accordance with the present disclosure, embodiments disclosed herein generally relate to a connection assembly and/or apparatus that may be used with a downhole tool, such as a tool provided within one or more of the embodiments shown in FIGS. 1-5, in addition to being included within other tools and/or devices that may be disposed downhole.

The connection assembly may include a connection apparatus, in which the connection apparatus includes a housing having a first end and a second end with a communication line disposed within the housing. The connection assembly may further include one or more cables, in which the cable also has a housing with a communication line disposed therein. As such, the communication line of the connection apparatus may be communicatively coupled to the communication line of the cable. Further, the first end of the housing of the connection apparatus may be connected to an end of the housing of the cable. For example, a weld coupling may be used to connect the first end of the housing of the connection apparatus to the end of the housing of the cable. The first end of the housing of the connection apparatus and the end of the housing of the cable may then have substantially the same diameter. Particularly, in one or more embodiments, the housing of the connection apparatus and the housing of the cable may have substantially the same diameter.

The connection assembly may further include a second cable, in which the connection apparatus may be disposed between the (first) cable, described above, and the second cable. Similar to the first cable, the second cable may also have a housing with a communication line disposed therein. The second end of the housing of the connection apparatus may be connected to an end of the housing of the second cable. For example, as similar to above, a weld coupling may be used to connect the second end of the housing of the connection apparatus to the end of the housing of the second cable. The second end of the housing of the connection apparatus and the end of the housing of the second cable may then have substantially the same diameter. Particularly, in one or more embodiments and similar to above, the housing of the connection apparatus and the housing of the second cable may have substantially the same diameter.

The connection assembly may further include a thermal insulator disposed about the communication line of the cables and/or the communication line of the connection apparatus. The thermal insulator may be used to protect the communication lines, such as by protecting from any heat dispersed when forming the weld couplings. Further, a crimp may be used to communicatively couple one or more ends of the communication lines together, and a crimp sleeve may be disposed about the crimp, such as to assist in securing the crimp in place with respect to the communication lines. The communication line of the connection apparatus may have a smaller diameter than that of the other communication lines, and the communication line of the connection apparatus may be, at least partially, coiled. One or more of the weld couplings used within the connection assembly may then be or include butt welds. Furthermore, in addition to the connection assembly having a first cable and a second cable, the connection assembly may include more cables, such as a third cable, in which the third cable may also be communicatively coupled to the connection apparatus. As such, the connection apparatus may be used to transmit power and/or data between the one or more cables connected to the connection apparatus.

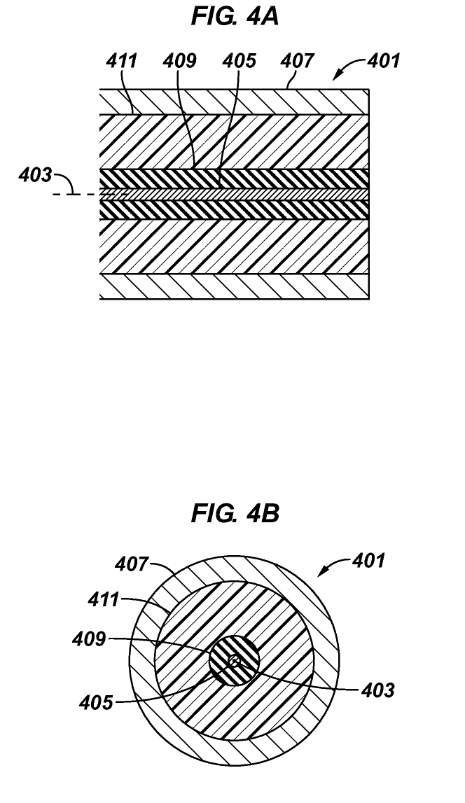

Referring now to FIGS. 4A and 4B, multiple views of a cable 401 used in accordance with one or more embodiments disclosed herein are shown. FIG. 4A shows a cross-sectional view of the cable 401 along an axis 403 of the cable 401, and FIG. 4B shows a cross-sectional view of the cable 401 across the axis 403 of the cable 401. As such, in this embodiment, the cable 401 includes the axis 403 extending therethrough, in which one or more elements of the cable 401 may be disposed about the axis 403 of the cable 401.

As shown, the cable 401 includes a communication line 405 and a housing 407. The housing 407 may be the outermost layer of the cable 401, thereby enabling the housing 407 to form the outer surface of the cable 401. The housing 407 is disposed about the communication line 405, in which the housing 407 may provide protection, such as structural protection, for the communication line 405. As such, the housing 407 may be formed from a rigid material, such as may be formed from and/or include a metallic material (e.g., steel), and/or any other material known in the art to provide protection within the cable 401. Further, the communication line 405 may be used to transmit power and/or data therethrough. As such, the communication line 405 may be an electrical line, a fiber optic line, and/or any other line or wire known in the art that may be used to transmit power and/or data therethrough.

Further, the cable 401 may include one or more layers of insulation to also provide protection for the communication line 405. For example, as shown in FIGS. 4A and 4B, a first insulative layer 409 and a second insulative layer 411 are included within the cable 401. In this embodiment, the first insulative layer 409 is disposed about the communication line 405, and the second insulative layer 411 is disposed about the first insulative layer 409 such that the second insulative layer is disposed between the first insulative layer 409 and the housing 407. As such, the first insulative layer 409 and the second insulative layer 411 may be formed may be formed using one or more materials.

For example, as shown, the first insulative layer 409 may be formed from a material that may be compatible to be in direct contact with the communication line 405. As such, in one embodiment, the first insulative layer 409 may be formed from an insulative material, such as a rubber and/or plastic material. In another embodiment, the first insulative layer 409 may be formed from a material having a lower index of refraction, such as compared to a fiber optic line. Further, the second insulative layer 411 may be formed of an insulative material desired to fill the space between the first insulative layer 409 and the housing 407. As such, in one embodiment, the second insulative layer 411 may be formed from and/or include a thermal insulative material, such as a plastic material, such as to prevent, at least a portion, of the heat from transferring from the housing 407 to the first insulative layer 409 and/or the communication line 405. Further, in another embodiment, the second insulative layer 411 may be formed from a material to increase the structural rigidity of the cable 401. As such, the first insulative layer and/or the second insulative layer may be formed and/or include one or more materials, such as materials known in the art, for the cable to have desired properties and structure.

The cable 401 may be used within one or more embodiments of the present disclosure. Further, those having ordinary skill in the art will appreciate that the present disclosure contemplates using other cables known in the art that transmit power and/or data therethrough. As such, the present disclosure should not be limited to the use of the cable as shown in FIGS. 4A and 4B, in addition to the cables shown in the previous or the following embodiments.

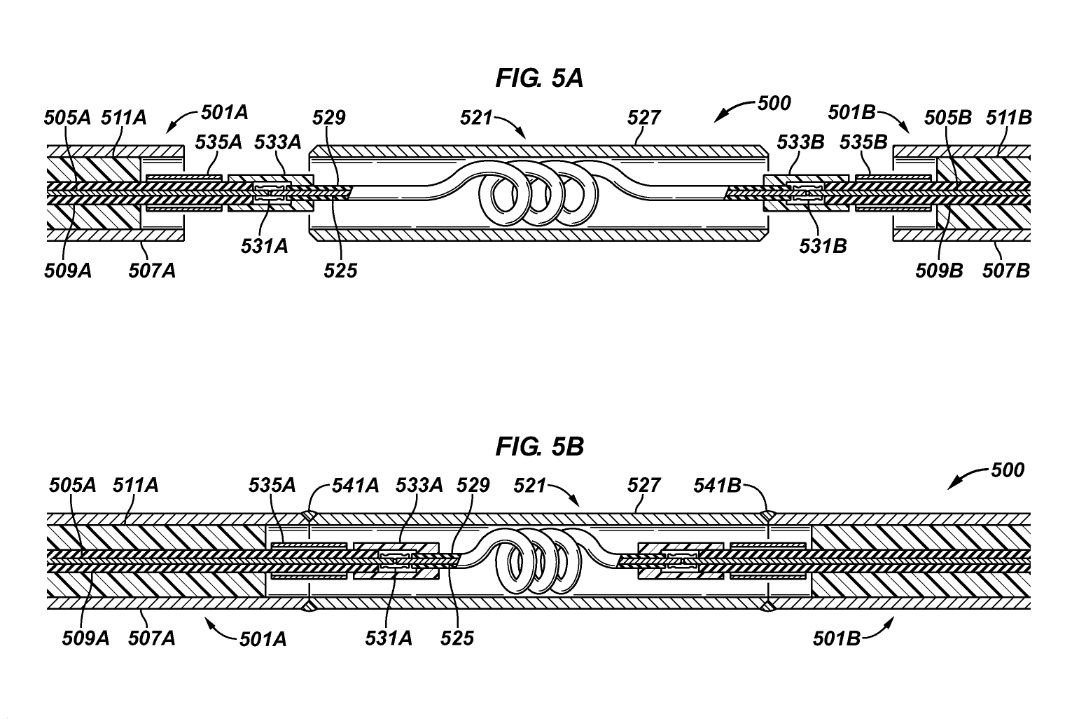

Referring now to FIGS. 5A and 5B, cross-sectional views along a connection assembly 500 in accordance with one or more embodiments of the present disclosure are shown. FIG. 5A shows the connection assembly 500 before being fully connected, and FIG. 5B shows the connection assembly 500 after being connected (discussed more below). The connection assembly 500 may include one or more cables 501 included therein. As such, in this embodiment, the connection assembly 500 includes a first cable 501A and a second cable 501B. As such, one or both of the cables 501A and 501B may be similar to the cable described above with respect FIG. 4, as shown in the embodiments in FIGS. 5A and 5B, or one or both of the cables 501A and 501B within the connection assembly 500 may be other cables known in the art.

In the embodiments shown, the cables 501A and 501B are substantially similar. As such, the cables 501A and 501B may be formed, for example, such as by cutting a larger cable using methods known in the art into the cables 501A and 501B. Thus, the cables 501A and 501B are shown in this embodiment as having similar size and structure. The cables 501A and 501B may each include a housing 507A and 507B and a communication line 505A and 505B, in which the communication line 505A and 505B may be disposed within the housing 507A and 507B. The communication line 505A and 505B may be capable of transmitting power and/or data therethrough.

Further, as similar to the cable shown in FIG. 4, the cables 501A and 501B in FIGS. 5A and 5B may include one or more insulative layers, such as a first insulative layer 509A and 509B and a second insulative layer 511A and 511B. As shown, the first insulative layer 509A and 509B may be disposed about the communication line 505A and 505B, and the second insulative layer 511A and 511B may be disposed about the first insulative layer 509A and 509B between the first insulative layer 509A and 509B and the housing 507A and 507B.

As mentioned, the connection assembly 500 may further include a connection apparatus 521. The connection apparatus 521 includes a housing 527 and a connection line 525, in which the connection line 525 is disposed within the housing 527. Similar to the connection lines 505A and 505B for the cables 501A and 501B, the connection line 525 of the connection apparatus 521 may be able to transmit power and/or data therethrough. As such, and as shown in FIGS. 5A and 5B, the housing 527 of the connection apparatus 521, or at least a portion thereof, may have substantially the same diameter as one or both of the housings 507A and 507B of the cables 501A and 501B. Further, the housing 527 of the connection apparatus 521 may be formed from and/or include a rigid material, such as a metallic material (e.g., steel), to provide structure and/or protection for the connection apparatus 521.

As shown, the connection line 525 of the connection apparatus 521 may be, at least partially, coiled. Further, the connection line 525 may have a smaller diameter than that of one or both of the connection lines 505A and 505B for the cables 501A and 501B. In this embodiment, the portion of the connection line 525 that is coiled is disposed within the housing 527. As such, the connection line 525 being coiled may enable one or more ends of the connection line 525 to be able to extend out from the connection apparatus 521. Furthermore, as shown, the connection line 525 may have an insulative layer 529 disposed thereabout. The insulative layer 529 may be formed from and/or include one or more of the materials described above, such as with respect to the insulative layers of the cable shown in FIG. 4, and/or may include other materials therein. For example, the insulative layer 529 may include a material having properties similar to a spring, thereby enabling the connection line 525 to coil. Those having ordinary skill in the art, though, will appreciate that other materials may be used for the insulative layer 529 for the connection line 525, in addition to being used within the other insulative materials of the present disclosure.

As such, in accordance with embodiments disclosed herein, the connection apparatus 521 of the present disclosure may be used within the connection assembly 500 to enable communication through the connection assembly 500. Particularly, as shown in FIGS. 5A and 5B, the connection apparatus 521 may be disposed between and connected to the cables 501A and 501B to enable communication, such as by transmitting power and/or data, between the cables 501A and 501B.

In the embodiment shown in FIGS. 5A and 5B, a portion of the communication line 505A and 505B of the cables 501A and 501B may be exposed, such as by not having the first insulative layer 509A and 509B and/or the second insulative layer 511A and 511B formed about the communication line 505A and 505B. This may be formed by, for example, stripping away the first insulative layer 509A and 509B and/or the second insulative layer 511A away from the communication line 505A and 505B. As such, in this embodiment, the end of the communication line 505A and 505B of the cables 501A and 501B do not have any insulation from insulative layers formed thereabout. Similarly, a portion of the communication line 525 of the connection apparatus 521 may be exposed, such as by having each end of the communication line 525 exposed and not having the first insulative layer 529 formed thereon.

Further, a portion of the first insulative layer 509A and 509B having the communication line 505A and 505B still disposed therein may be exposed, such as by not having the second insulative layer 511A and 511B formed about the first insulative layer 509A and 509B. Particularly, as shown, the end of the first insulative layer 509A and 509B of the cables 501A and 501B do not have any further insulation formed thereabout. These portions of the communication lines 505A and 505B and the first insulative layers 509A and 509B may be selectively exposed, as desired, to facilitate a connection between the cables 501A and 501B and the connection apparatus 521.

To enable power and/or data to transmit through the connection assembly 500, the communication lines 505A, 505B, and 525 may be communicatively coupled to each other. As such, depending on the particular type of communication lines 505A, 505B, and 525 used within the connection assembly 500, one or more of the communication lines 505A, 505B, and 525 may be spliced to communicatively couple the communication lines 505A, 505B, and 525 together. For example, the communication lines 505A, 505B, and 525 may use a fusion splice, mechanical splice, any other splice known in the art, and/or any other method and/or device to enable the communication lines 505A, 505B, and 525 to communicatively couple to each other. Further, having the communication lines 505A, 505B, and 525 exposed may facilitate communicatively coupling the communication lines 505A, 505B, and 525 to each other.

Referring still to FIGS. 5A and 5B, the connection assembly 500 may include one or more components to facilitate the connection between the connection apparatus 521 and one or both of the cables 501A and 501B. For example, as shown, the connection assembly 500 may include one or more crimps 531, one or more crimp sleeves 533, and/or one or more thermal insulators 535.

In the embodiment shown, the connection assembly 500 includes two crimps 531A and 531B. As such, the crimps 531A and 531B may be used to particularly facilitate communicatively coupling the communication lines 505A, 505B, and 525 to each other. For example, as shown, the first crimp 531A may be disposed about the end of the communication line 505A of the first cable 501A and disposed about the end of the communication line 525 of the connection apparatus 521. Specifically, the first crimp 531A may be disposed about the exposed portions of the end of the communication line 505A and of the end of the communication line 525.

Similarly, the second crimp 531B may be disposed about the end of the communication line 505B of the second cable 501B and disposed about the other end of the communication line 525 of the connection apparatus 521, such as particularly disposed about the exposed portions of the end of the communication line 505B and of the other end of the communication line 525. As such, the crimps 531A and 531B may enable the end of the communication line 505A, 505B, and 525 to remain substantially stationary with respect to each other, thereby facilitating and/or protecting the communicative coupling of the communication lines 505A, 505B, and 525 with each other.

Further, in the embodiment shown, the connection assembly 500 may include two crimp sleeves 533A and 533B. For example, as shown, the first crimp sleeve 533A may be disposed about the first crimp 531A, thereby enhancing the connection of the first crimp 533A to the end of the communication line 505A and the end of the communication line 525. Similarly, the second crimp sleeve 533B may be disposed about the second crimp 531B, thereby enhancing the connection of the second crimp 533B to the end of the communication line 505B and the other end of the communication line 525. As such, the crimp sleeves 533A and 533B may be used to facilitate and/or protect the communicative coupling of the communication lines 505A, 505B, and 525 with each other.

Furthermore, in the embodiment shown, the connection assembly 500 may include two thermal insulators 535A and 535B. The thermal insulators 535A and 535B may be disposed about one or more of the communication lines 505A, 505B, and 525, thereby protecting the communication lines 505A, 505B, and 525 from heat that may damage the communication lines 505A, 505B, and 525. For example, as shown in FIGS. 5A and 5B, the first thermal insulator 535A is disposed about the communication line 505A, such as to provide thermal protection to the communication line 505A. Particularly, the first thermal insulator 535A may be disposed about the first insulative layer 509A adjacent to the communication line 505A.

Similarly, the second thermal insulator 535B is disposed about the communication line 505B to provide thermal protection to the communication line 505B. As such, the thermal insulators 535A and 535B may be selectively positioned within the connection assembly 500 to provide thermal protection to the connection assembly 500 at desired locations. For example, in the embodiment shown in FIGS. 5A and 5B, the thermal insulators 535A and 535B may be used to provide thermal protection to the communication lines 505A and 505B at the locations adjacent to one or more weld couplings (discussed more below).

Accordingly, as shown from FIG. 5A to FIG. 5B, the connection apparatus 521 may be connected between the first cable 501A and the second cable 501B. In accordance with one or more embodiments of the present disclosure, to connect the connection apparatus 521 to the first cable 501A and/or the second cable 501B, the connection assembly 500 may use one or more weld couplings. For example, as shown in FIG. 5B, a first weld coupling 541A may be used to connect the connection apparatus 521 to the first cable 501A. Particularly, the first weld coupling 541A may be used to connect the end of the housing 527 of the connection apparatus 521 to the end of the housing 507A of the first cable 501A. Further, as shown, a second weld coupling 541B may be used to connect the connection apparatus 521 to the second cable 501B. Particularly, the second weld coupling 541B may be used to connect the other end of the housing 527 of the connection apparatus 521 to the end of the housing 507B of the second cable 501B. As such, the housings 507A, 507B, and 527 may be formed from and/or include a material, such as a metal, to facilitate the weld couplings 541A and 541B connecting the housings 507A, 507B, and 527 to each other.

As mentioned, when connecting the housings 507A, 507B, and 527 to each other, a weld coupling may be used. As such, and as shown, a butt weld may be used to connect one or more of the housings 507A, 507B, and 527 to each other. A butt weld may be used to connect the ends of the housings to each other, thereby providing a reliable connection between the ends of the housings. Further, a butt weld may be used to maintain a consistent diameter between the ends of the housings. As such, the diameter at the location of the butt weld may be substantially the same as the diameter of one or more of the housings within the connection assembly. A butt weld may include a V-butt weld, a J-butt weld, a single butt weld, a double butt weld, and/or any other type of butt weld known in the art. However, those having ordinary skill in the art will appreciate that other weld couplings may be used in accordance with embodiments disclosed herein without departing from the scope of the present disclosure.

Further, as mentioned above, one or more housings of the cables and/or the connection apparatus may have substantially the same diameter, or may have portions thereof with substantially the same diameter. For example, as shown in FIGS. 5A and 5B, the housings 507A, 507B, and 527 each have substantially the same diameter with respect to each other. As such, the connection assembly 500 may have a substantially consistent diameter from the first cable 501A through the connection apparatus 521 to the second cable 501B. However, in one embodiment, only one or more of the ends of the housings may have substantially the same diameter. For example, with reference to FIGS. 5A and 5B, rather than the housing 507A of the first cable 501A having substantially the same diameter as the housing 525 of the connection apparatus 521, only the end of the housing 507A and the end of the housing 525 connected to each other may have substantially the same diameter.

As shown in FIGS. 5A and 5B, the connection assembly 500 may include two cables 501A and 501B. However, in one or more embodiments, the connection assembly 500 may include more than two cables, such as by having a third cable. For example, in one embodiment, the connection apparatus may include a first end, a second end, and a third end, in which the housing and the communication line of the second end and the third end of the connection apparatus couple to and extend from the first end of the connection apparatus. The connection assembly may enable the communication line of the third cable to be communicatively coupled to the communication line of the third end of the connection apparatus. Further, the housing of the third cable may then be connected, such as through a weld coupling, to the housing of the third end of the connection apparatus. In such an embodiment, the ends of the housings may have substantially the same diameter.

In accordance with an aspect of the present disclosure, the present disclosure may include one or more additional components disposed therein and/or communicatively coupled thereto. For example, in one or more embodiments, a signal amplifier and/or a repeater may be included within a connection assembly of the present disclosure. In such an embodiment, the signal amplifier and/or the repeater may be included within connection assembly, such as by particularly having the signal amplifier and/or the repeater disposed within the connection apparatus of the connection assembly. As such, the signal amplifier and/or the repeater may be disposed within the housing of the connection apparatus, in which the signal amplifier and/or the repeater may be communicatively coupled to the communication line of the connection apparatus. Thus, the signal amplifier and/or the repeater may be used within the connection assembly, in addition to being used with other devices and/or tools in communication with the connection assembly. Those having ordinary skill in the art will appreciate that other components, in addition or in alternative to a signal amplifier and/or a repeater, may also be included within a connection assembly of the present disclosure.

In accordance with another aspect of the present disclosure, the present disclosure may relate to one or more methods to communicatively couple one or more cables to each other. The method may include receiving a first cable and a second cable, in which the first cable and the second cable may be formed from a larger cable, such as by cutting the larger cable. Insulation within the first cable and the second cable may then be removed, such as by removing one or more of the insulative layers within the first cable and/or the second cable to expose portions of the communication lines within the cables. The communication lines may then be communicatively coupled to each other, such as by communicatively coupling a connection apparatus having a communication line between the communication lines of the cables. Further, the connection apparatus and the cables may be connected to each other, such as by welding the housings of the cables and/or the connection apparatus to each other. One or more thermal insulators may also be included within the connection assembly to insulate the connection lines from the welding and the weld couplings. As such, power and/or data may then be transmitted through the connection assembly, from the first cable through the connection apparatus to the second cable.

In accordance with another aspect of the present disclosure, the connection assembly may be disposed between a downhole tool and a source, thereby enabling the downhole tool and the source to communicate with each other. For example, a cable of the connection assembly may be connected to a downhole tool, such as a packer, a sensor, and/or any other downhole tool known in the art, and another cable of the connection assembly may be connected to a source, such as a power and/or data source disposed on the surface of a well. As such, power and/or data may then be transmitted through the connection assembly to enable communication between the downhole tool and the source.

Embodiments disclosed herein may provide for one or more of the following advantages. First, embodiments disclosed herein may provide for a connection assembly having a substantially consistent diameter. For example, when a first cable and a second cable may need to connected to each other, a connection assembly in accordance with one or more embodiments disclosed herein may be used to minimize the overall size of the diameter. Further, embodiments disclosed herein may be used within one or more downhole applications. For example, a connection assembly in accordance with one or more embodiments disclosed herein may be able to withstand one or more of the hostile conditions usually present within downhole applications. Furthermore, embodiments disclosed herein may be used to quickly and efficiently connect one or more cables to each other. For example, a connection assembly in accordance with one or more embodiments disclosed herein may be used to connect two cables to each other, such as at the location of a wellsite, to prepare the cables for connection with one or more downhole tools and/or other devices.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow the reader to quickly ascertain the nature of the technical disclosure. It is submitted with the understanding that it will not be used to interpret or limit the scope or meaning of the claims.

What is claimed is:

1. A connection assembly to be used with a downhole tool, the assembly comprising:
a first cable having a housing with a communication line disposed therein;
a second cable having a housing with a communication line disposed therein; and
a connection apparatus, comprising:
a housing having a first end and a second end; and
a communication line disposed within the housing;
the communication line of the connection apparatus communicatively coupled between the communication line of the first cable and the communication line of the second cable;
the first end of the housing of the connection apparatus connected to the housing of the first cable using a first weld coupling;
the second end of the housing of the connection apparatus connected to the housing of the second cable using a second weld coupling; and
the housing of the connection apparatus having substantially the same diameter as the housing of the first cable and the housing of the second cable.

2. The connection assembly of claim 1, further comprising:
a thermal insulator disposed about at least one of the communication line of the first cable and the communication line of the connection apparatus;
the thermal insulator disposed between the first weld coupling and the at least one of the communication line of the first cable and the communication line of the connection apparatus.

3. The connection assembly of claim 1, wherein at least one of the first weld coupling and the second weld coupling comprises a butt weld, wherein the butt weld is substantially the same diameter as the housing of the connection apparatus.

4. The connection assembly of claim 1, wherein the communication line disposed within the housing of the connection apparatus is at least partially coiled.

5. The connection assembly of claim 1, wherein the communication line of the connection apparatus has a smaller thickness than the communication line of the first cable and the communication line of the second cable.

6. The connection assembly of claim 1, wherein communication line of the connection apparatus is one of an electrical line and a fiber optic line.

7. The connection assembly of claim 1, wherein communication line of the connection apparatus is configured to transmit at least one of power and data therethrough between the communication line of the first cable and the communication line of the second cable.

8. The connection assembly of claim 1, further comprising a crimp disposed about an end of the communication line of the connection apparatus and an end of the communication line of the first cable and a crimp sleeve disposed about the crimp.

9. The connection assembly of claim 1, further comprising at least one of a signal amplifier and repeater disposed within the housing of the connection apparatus and communicatively coupled to the communication line of the connection apparatus.

10. A connection assembly to communicatively couple one or more cables together, the connection assembly comprising:
a cable having a housing with a communication line disposed therein;
a connection apparatus having a housing with a communication line disposed therein; and
a weld coupling disposed between an end of the housing of the connection apparatus and an end of the housing of the cable such that the end of the housing of the connection apparatus and the end of the housing of the cable are connected to each other through the weld coupling;
the communication line of the connection apparatus communicatively coupled to the communication line of the cable; and
the end of the housing of the connection apparatus having substantially the same diameter as the end of the housing of the cable.

11. The connection assembly of claim 10, wherein the housing of the connection apparatus has substantially the same diameter as the housing of the cable.

12. The connection assembly of claim 10, wherein the weld coupling is a butt weld.

13. The connection assembly of claim 10, wherein the housing of the connection apparatus comprises a second end, the connection assembly further comprising:
a second cable having a housing with a communication line disposed therein;
the communication line of the connection apparatus communicatively coupled to the communication line of the second cable;
the second end of the housing of the connection apparatus connected to an end of the housing of the second cable using a second weld coupling; and
the second end of the housing of the connection apparatus having substantially the same diameter as the end of the housing of the second cable.

14. The connection assembly of claim 13, wherein the housing of the connection apparatus comprises a third end, the connection assembly further comprising:
a third cable having a housing with a communication line disposed therein;
the communication line of the connection apparatus communicatively coupled to the communication line of the third cable;
the third end of the housing of the connection apparatus connected to an end of the housing of the third cable using a third weld coupling; and
the third end of the housing of the connection apparatus having substantially the same diameter as the end of the housing of the third cable.

15. The connection assembly of claim 10, wherein the communication line disposed within the housing of the connection apparatus is at least partially coiled.

16. The connection assembly of claim 10, wherein the communication line of the connection apparatus is configured to transmit at least one of power and data therethrough.

17. A method to communicatively couple one or more cables together, the method comprising:
communicatively coupling a communication line of a connection apparatus to a communication line of a first cable;
communicatively coupling the communication line of the connection apparatus to a communication line of a second cable;
welding a first end of a housing of the connection apparatus to an end of a housing of the first cable with a first weld coupling; and
welding a second end of the housing of the connection apparatus to an end of a housing of the second cable with a second weld coupling;
wherein the communication line of the connection apparatus is disposed, at least partially, within the housing of the connection apparatus; and
wherein the housing of the connection apparatus has substantially the same diameter as the housing of the first cable and the housing of the second cable.

18. The method of claim 17, wherein at least one of the first weld coupling and the second weld coupling comprises a butt weld, and wherein the communication line disposed within the housing of the connection apparatus is at least partially coiled.

19. The method of claim 17, further comprising:
disposing a crimp about an end of the communication line of the connection apparatus and an end of the communication line of the first cable;
disposing a crimp sleeve about the crimp; and
disposing a thermal insulator about at least one of the communication line of the first cable and the communication line of the connection apparatus.

20. The method of claim 17, further comprising:
forming the first cable and the second cable from a longer cable;
removing insulation between the housing and the communication line of the first cable before communicatively coupling the communication line of the connection apparatus to the communication line of the first cable; and
transmitting at least one of power and data through the communication line of the connection apparatus between a source and a downhole tool.
